(19) United States
(12) Patent Application Publication
(10) Pub. No.: US 2016/0257035 A1
(43) Pub. Date: Sep. 8, 2016

(54) METHOD FOR PRODUCING A POLYMER MEMBRANE OF A POLYMER MEMBRANE ELECTRODE FOR THE POTENTIOMETRIC DETECTION OF AT LEAST ONE ANALYTE PRESENT IN A SOLUTION

(71) Applicant: COMMISSARIAT À L'ÉNERGIE ATOMIQUE ET AUX ÉNERGIES ALTERNATIVES, Paris (FR)

(72) Inventors: Julien FILS, Saint Quentin Sur Isere (FR); Gael CASTELLAN, Engins (FR); Aurelien LAMBERT, Saint-Jen -De-sixt (FR)

(73) Assignee: COMMISSARIAT A L'ENERGIE ATOMIQUE ET AUX ENERGIES ALTERNATIVES, Paris (FR)

(21) Appl. No.: 15/033,295

(22) PCT Filed: Oct. 29, 2014
(86) PCT No.: PCT/EP2014/073185

§ 371 Date: Apr. 29, 2016

(30) Foreign Application Priority Data
Oct. 29, 2013 (FR) 13 60572

(51) Int. Cl. B29C 39/02; G01N 27/333; B29C 39/00

(52) U.S. Cl. CPC B29C 39/02; B29C 39/003; G01N 27/3335; B29K 2027/06

(57) ABSTRACT

A method for developing a polymer membrane of a polymer membrane electrode intended for the potentiometric detection of at least one analyte present in a solution to be analysed, the method including: depositing a solution, in the liquid phase, including the constituents of the polymer membrane at the surface of an internal electrolyte solution, the latter being in the liquid phase and occupying the internal cavity of an electrode body; drying the solution including the constituents of the polymer membrane, resulting in the polymer membrane at the surface of the internal electrolyte solution.

### TECHNICAL FIELD

The invention relates to a method for preparing a polymer membrane of a membrane electrode intended for the potentiometric quantitative detection of at least one analyte present in a solution.

It is specified that, by analyte, we mean a chemical species present in solution, which may more specifically be chosen from ions or organic compounds of interest (such as urea, glucose).

The invention is therefore applicable in the field of chemical sensors including electrodes of the type mentioned above.

Such sensors, in particular when they are intended for ion detection, are useful in the environmental or sanitary fields, in particular for water quality management. They may in particular be used in water analysis laboratories, in order to measure the concentration of certain ions, in order to thus access the water hardness.

Such sensors may also be useful in other fields, such as:
the medical field and more specifically the field of diagnostics, for example for analysis of blood constants in order to detect certain pathologies, such as kidney failure;
the pharmaceutical field;
the field of agriculture, in particular water analysis; and
the industrial field, such as, for example, thermal power plants for determining the degree of fouling of the latter, in particular at the level of cooling circuits.

### PRIOR ART

At present, numerous methods have been established for the detection of analytes, such as ions, among which the following may be cited:
flame ionization detection, in which the eluate to be analysed penetrates a flame obtained by combustion of hydrogen and air, whereby ions are formed and collected by two electrodes, resulting in an electric current, which is recorded and correlated with the quantity of ions detected;
flame photometry detection, in which the ions to be detected are subjected to the heat of a flame characterized by the passage of said ions to an excited state; the return to the fundamental state of the electrons of the outer layer is performed with light emission characteristic of the ions present, the intensity of said emission being proportional to the concentration of said ions;
colorimetry detection, in which the analytes to be detected are placed in contact with a reagent capable of reacting with them in order to form a coloured compound, which will be analysed by absorption measurement in order to rise to the concentration of said analytes.

While these methods generally demonstrate high sensitivity, they are nevertheless invasive methods, which are accompanied by a disruption of the medium to be analysed from the perspectives of both chemistry and, as the case may be, electricity.

To counter this type of disadvantage, it has been possible, since the 1960s, to use a method of detection of analytes by potentiometry, the principle of which is based upon the following:
the measurement of the difference in potential, which occurs between two electrodes (respectively, an indicator electrode and a reference electrode) due to the activity of the analyte present in the sample; and
the determination of the activity of the analyte by applying the Nernst equation on the basis of values of the difference in potential.

As suggested above, a device making it possible to establish this method includes at least one cell including an indicator electrode and a reference electrode that are immersed in the solution to be analysed, said electrodes being connected to at least one unit making it possible to measure variations in electric potential and optionally correlate said variations with the activity of the analyte to be detected.

While these units make it possible to measure only variations in electric potential, a previously established abacus may be used to identify correlations between variations in electric potential and the activity of the analyte contained in the solution.

The reference electrode is an electrode of which the potential E_{ref}, precisely known, is independent of the concentration of the analyte and any other species present in the solution to be analysed. Classically, this reference electrode may be a calomel electrode or an Ag/AgCl electrode.

The indicator electrode is a measurement electrode that develops, in contact with the solution to be analysed, a potential E_{ind}, which is a function of the activity of the analyte.

This electrode may be in the form of a membrane electrode, in which the membrane is selective of the analyte of which the presence is to be determined. This electrode, when intended for determining ions, may be qualified as an ion-selective electrode (ISE).

Generally, three types of membrane electrodes are distinguished:
glass membrane electrodes;
crystalline membrane electrodes;
liquid membrane electrodes; and
polymer membrane electrodes.

This last category tends to supplant the other categories, because they are in particular more flexible than the crystalline membrane electrodes and they are more robust and clearly more sensitive to solubilisation than the liquid membrane electrodes.

These membrane electrodes, as shown in FIG. 1, classically exist in the form of a tube (reference 3), for example cylindrical, which may be made of a polymer material (such as a vinyl material such as polyvinyl chloride) having an upper end 5 and a lower end 7, the latter being intended to be in contact with the solution to be analysed. To do this, the lower end 7 is closed off by a so-called sensitive and selective polymer membrane, because it will be capable of preferentially capturing an analyte of a specific species. In addition, the aforementioned tube has an internal cavity 9 filled with an internal electrolyte solution (or internal filling solution or more simply electrolyte) classically consisting of an aqueous solution including a salt, for example, an alkaline salt such as NaCl, in which an electrical contact element 11 is immersed (said element being capable of being qualified as a contact electrode because it is used to “recover” the potential induced by the fixation of the analyte on the membrane).

As indicated in the article of Faridbod et al., African Journal of Biotechnology Vol.6 (25), pages 2960-2987, the polymer membranes are produced according to two major synthetic pathways.

The first synthetic pathway consists in casting, on a support, the polymer membrane precursor solution, then, after drying, cutting, with a punch, the polymer membrane, which will then be adhered to one of the ends (that intended to be subsequently in contact with the solution to be analysed) of an electrode body. This synthetic pathway in particular has the disadvantage of being time-consuming and costly to implement.

The second synthetic pathway consists in immersing a hollow electrode body via one of its ends (that intended to be subsequently in contact with the solution to be analysed) in a membrane precursor solution, then, after removal, leaving the solution deposited at said end, resulting in the polymer membrane.

According to these two synthetic pathways, the internal electrolyte solution is introduced into the electrode body after the polymer membrane has been formed, which may cause air to be trapped between the internal electrolyte solution and the polymer membrane previously formed, and which hinders the use of the electrode in all directions.

The inventors have set out to propose a new method for developing a polymer membrane for a membrane electrode not having the above-mentioned disadvantages, and in particular that of the presence of air between the internal electrolyte solution and the polymer membrane.

### DESCRIPTION OF THE INVENTION

To do this, the invention relates to a method for making a polymer membrane of a polymer membrane electrode intended for the potentiometric detection of at least one analyte present in a solution to be analysed, said method including the following series of steps:
a) a step of depositing a solution, in the liquid phase, including the constituents of the polymer membrane at the surface of an internal electrolyte solution, the latter being in the liquid phase and occupying the internal cavity of an electrode body;
b) a step of drying said solution including the constituents of the polymer membrane, resulting in the polymer membrane at the surface of the internal electrolyte solution.

It is specified that, by internal electrolyte solution, we mean the solution that forms the junction, in the internal cavity of the electrode, between the polymer membrane and the electrical contact element. The electrical contact element may be a metal electrode or the gate of a transistor, in order to form, for example, an ISFET transistor (ion selective field effect transistor). The following terms may also be used instead of the term internal electrolyte solution: internal filling solution, internal reference solution or, more simply, electrolyte.

It is specified that, by surface of an internal electrolyte solution, classically what is meant is the surface that is level, in the open air, with one of the ends of the electrode body.

The polymer membrane may, in particular, be an ion-selective polymer membrane (which may thus be qualified as ISE membrane), when the analyte is an ion.

In this case, the solution including the constituents of the membrane may include:
at least one polymer as such, intended to form a polymer matrix;
at least one active substance intended to capture the ion(s), constituting the key element controlling the response of the electrode;
at least one organic solvent, for example, apolar; and
optionally, one or more plasticizing agents used, in particular, in order to reduce the glass transition temperature of the polymer(s) and thus soften them.

The polymer(s) intended to form the polymer matrix may be vinyl polymers, such as polyvinyl chloride, polysiloxanes and polyurethanes.

To prepare the solution containing the constituents of the membrane, it is possible to form a mixture, called the initial mixture, comprising the constituents of the membrane mentioned above, to which a solvent is added.

The initial mixture may include a polymer mass content ranging from 20% to 50% and usually 25% to 35% by mass with respect to the total mass of the initial mixture. An appropriate polymer may be polyvinyl chloride.

As mentioned above, the initial mixture includes the active substance(s) intended to capture the ion(s), which include:
ionophore compounds; and
optionally, ion exchange materials, which may make it possible to adjust the conductivity of the membrane.

The active substance(s) may form between 1 and 10% by mass of the total mass of the initial mixture.

Suitable ionophore compounds may be organic compounds forming a cage, such as so-called “crown” compounds.

As an example, mention may be made of calixarene compounds, such as 4-tert-butylcalix[4]arene-tetraacetic acid tetraethyl ester, which in particular have the capacity to trap sodium ions Na+ (said compound being sold by Sigma Aldrich under the name Ionophore X).

As an example, mention may be made of “crown ether”-type compounds, such as 2-dodecyl-2-methyl-1,3-propanediyl bis[N-[5′-nitro(benzo-15-couronne-5)-4′-yl]carbamate], which in particular has the capacity to trap potassium ions K⁺ (said compound being sold by Sigma Aldrich under the name Ionophore III).

The plasticizing agent(s) may be chosen from the adipic acid diesters, such as, for example, dioctyl adipate (known by the abbreviation DOA).

The plasticizing agent(s) may be contained in the initial mixture in a proportion greater than that of the aforementioned polymer(s).

The plasticizing agent(s) may be contained in an amount of 40 to 80%, for example, or 55 to 65% by mass, with respect to the total mass of the initial mixture.

To this initial mixture, an organic solvent, for example an apolar organic solvent, is added. This solvent may be chosen from the cyclic ethers, such as tetrahydrofuran. The added quantity by mass of solvent may be between 1 and 10 times the mass of the initial mixture.

Certain constituents of the solution including the constituents of the membrane are, advantageously, non-miscible with the internal electrolyte solution. These include in particular polymer(s), ionophore compound(s). The plasticizer(s) may be miscible with the internal electrolyte solution, on the condition that they have a higher chemical affinity for the polymer(s) than the internal electrolyte solution. Thus, once deposited, the solution containing the constituents of the membrane remains at the surface of the internal electrolyte solution.

The solution containing the constituents of the polymer membrane may be prepared by a method including the following steps:
a step of preparing the initial mixture mentioned above;
a step of adding a solvent to the initial mixture; and
a step of mixing until a homogeneous solution is obtained.

As mentioned above, step a) includes a step of depositing a solution containing the constituents of the polymer membrane at the surface of an internal electrolyte solution, the latter being in the liquid phase and occupying the internal cavity of an electrode body.

By liquid phase, we generally mean, above and below, a phase having a viscosity below 10,000 cP.

This internal electrolyte solution may by constituted by an aqueous solution, a solution containing glycerin, a solution containing a mixture including glycerin and water, or it may also be an ionic liquid, with the understanding that this internal electrolyte solution is in liquid form.

From a practical perspective, this step a) may consist in depositing one or more drops of the solution including the constituents of the membrane, for example, by means of a pipette, at the surface of the internal electrolyte solution filling the internal cavity of the electrode body. This technique may thus be qualified as “drop casting”.

It is understood that the volume of solution containing the constituents of the polymer membrane will be chosen so as to occupy at least the entire surface of the internal solution level with one of the ends of the electrode body, which means, in other words, that the volume of the solution may be chosen so as to overflow from the level surface of the internal solution.

More specifically, the internal electrolyte solution may be an aqueous solution capable of including, in addition, one or more salts, such as salts chosen, for example, from:
alkaline salts, such as sodium chloride (NaCl), potassium chloride (KCl);
alkaline earth salts such as calcium chloride (CaCl₂).

As suggested above, it may also be an internal electrolyte solution containing at least one solvent, which is glycerin.

Such an internal electrolyte solution may include a single solvent, which is glycerin (which means, in other words, that the glycerin content in the solvent is 100%) or may include a mixture of solvents including glycerin, for example, a mixture consisting of glycerin and water.

In the case of a solvent mixture, said solvent mixture may include glycerin, preferably, in an amount of at least 30% by mass with respect to the total mass of the solvent mixture, said solvent mixture including, in addition to glycerin, preferably water.

Also preferably, the mixture of solvents includes glycerin in an amount of at least 50%, advantageously 50% to 80%, and in particular 60% to 70%, by mass with respect to the total mass of the solvent mixture.

Aside from glycerin, such a solution may also include one or more salts, for example, chosen from:
the alkaline salts, such as sodium chloride (NaCl), potassium chloride (KCl);
the alkaline earth salts such as calcium chloride (CaCl₂).

The salt(s) may be present, in the solution, in a concentration ranging from 10⁻⁶ mol/L to a saturation concentration, preferably 10⁻⁶ mol/L to 3 mol/L, for example 100 mmol/L.

Once step a) has been implemented, the method of the invention includes a step b) of drying said solution containing the constituents of the polymer membrane, resulting in the polymer membrane at the surface of the internal electrolyte solution.

Preferably, the polymer membrane closes off the electrode body.

This drying step may consist in leaving the solution thus deposited in the open air (i.e. at room temperature) for a time sufficient to enable volatile constituents (such as the organic solvent(s)) to evaporate, or it may consist in placing it in a heated oven, i.e. at a temperature high enough (above the room temperature outside the oven) to enable the volatile constituents of the solution to evaporate. The drying may also be performed by exposure to infrared radiation. This embodiment makes it possible to heat primarily the membrane, while preserving the electrolyte or the electrode body, thus limiting the risks of degradation.

In addition, the method may include, before the implementation of step a), a step of filling the internal cavity of an electrode body with an internal electrolyte solution as defined below.

In the context of the method of the invention, the electrode body may be in the form of a hollow body (for example a hollow cylindrical tube or a parallelepiped chamber), one of the ends of which (referred to below as the first end) opens outwardly and the external surface of which is delimited by that of the internal electrolyte solution. Said hollow body may include another end, for example diametrally opposed to the first end, closed off by an electrical contact element, said internal electrolyte solution forming the junction between said membrane and said electrical contact element.

The electrode body may be made of a polymer material, such as a polyvinyl material (such as polyvinyl chloride), a polyolefin material (such as polypropylene), a polymethacrylate material (such as polymethyl methacrylate) or a polycarbonate material.

The electrical contact element may be a metal rod, one end of which is immersed in the internal electrolyte solution and the other end of which is connected to the external circuit. It may also be in the form of a metal pellet, such as a silver pellet.

Thus, once the polymer membrane has been obtained, the resulting product is a membrane electrode, which is in the form of an electrode body, the internal cavity of which is filled with an internal electrolyte solution, which is in contact with the polymer membrane obtained, which closes off the electrode body.

The membranes obtained by the method of the invention may be spherical membranes, capable of having a diameter ranging from 0.5 mm to several cm, preferably, between 0.5 and 2 mm and capable of having a thickness ranging from 0.3 to 1 mm.

The method of the invention can make it possible to obtain a membrane having a low surface area, the diameter of which is less than 5 mm, or even less than 1 mm. It is particularly suitable for the production of low-volume electrodes, which are suitable for small volumes of samples and/or compact analysis devices, for example portable devices.

As suggested above, the polymer membrane electrodes are intended for the potentiometric detection of at least one analyte present in a solution, which means, in other words, that said electrodes are intended to be integrated in chemical sensors.

Said chemical sensors for the potentiometric detection of an analyte present in a solution classically include, as shown in FIG. 2, at least one cell 13, including:
at least one polymer membrane electrode 15;
at least one reference electrode 17;
said electrodes being connected to a unit 19 enabling variations in electric potential between the polymer membrane electrode and the reference electrode to be measured.

Said reference electrode may classically be a calomel electrode or an Ag/AgCl electrode.

As mentioned above, the method of the invention may enable electrodes having a low surface area to be produced. Moreover, the method of the invention may have the following advantages:
it is easily industrialisable, the deposition of the solution including the constituents of the membrane capable of being performed by means of an automated liquid dispensing machine;
it has an unlimited number of steps; and
it is easy to implement.

Other features and advantages of the invention will become clear from the following additional description of an example of an embodiment of the method according to the invention.

Of course, said additional description is provided only for the purpose of illustration of the invention and is in no way limiting.

### BRIEF DESCRIPTION OF THE FIGURES

FIG. 1 shows a transverse cross-section of a polymer membrane electrode.

FIG. 2 shows a transverse cross-section of a chemical sensor including a polymer membrane electrode.

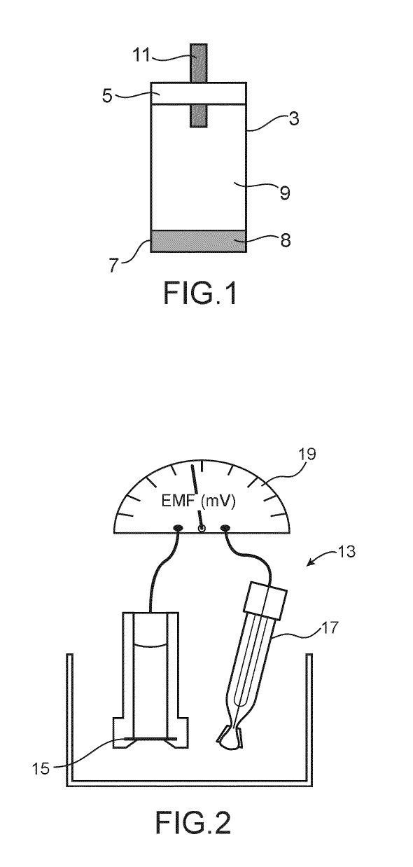

### DETAILED DESCRIPTION OF SPECIFIC EMBODIMENTS

### Example 1

In this example, the preparation of a polymer membrane according to the invention (called first electrode) is carried out.

To do this, a small element in the form of a parallelepiped chamber having a height of 5 mm and two opposite faces (one of which opens outwardly before the membrane is formed) having a surface of 4*4 mm is filled with an internal electrolyte solution containing only glycerin and NaCl 100 mM until it is level with the open face of the element. On the level internal solution surface, a drop of 500 μL of the polymer membrane solution is deposited, which is obtained from an initial mixture, to which a solvent is added.

The aforementioned initial mixture includes the following ingredients:
polyvinyl chloride in an amount of 30% by mass with respect to the total mass of the initial mixture;
a specific plasticizing agent: dioctyl adipate (also called DOA) in an amount of 60% by mass with respect to the total mass of the initial mixture;
a specific calixarene ionophore compound: 4-tert-butylcalix[4]arene-tetraacetic acid tetraethyl ester sold by Sigma-Aldrich under the name Ionophore X, said compound being present in an amount of 5% by mass of the total mass of the initial mixture;
a specific ion conducting compound: tetradodecylammonium tetrakis(4-chlorophenyl)borate salt, said compound being present in an amount of 5% by mass with respect to the total mass of the initial mixture.

To this initial mixture, a solvent (tetrahydrofuran) is added, the added mass of solvent being between one and two times the mass of the mixture.

This polymer solution is non-miscible with the internal electrolyte solution.

The polymer solution thus deposited is then dried in the open air for 3 hours, resulting in a membrane having a thickness of 1 mm.

1-5. (canceled)

6. A method for making a polymer membrane of a polymer membrane electrode intended for the potentiometric detection of at least one analyte present in a solution to be analysed, said method comprising:
a) depositing a solution, in the liquid phase, including the constituents of the polymer membrane at the surface of an internal electrolyte solution, the latter being in the liquid phase and occupying the internal cavity of an electrode body;
b) drying said solution including the constituents of the polymer membrane, resulting in the polymer membrane at the surface of the internal electrolyte solution.

7. The method according to claim 6, wherein the polymer membrane is an ion-selective polymer membrane, when the analyte is an ion.

8. The method according to claim 6, wherein the solution including the constituents of the membrane comprises:
at least one polymer;
at least one active substance intended to capture the analyte(s);
at least one organic solvent; and
optionally, one or more plasticizing agents.

9. The method according to claim 6, further comprising, before implementation a), filling the internal cavity of an electrode body with an internal electrolyte solution.

10. The method according to claim 6, wherein b) is performed at room temperature or in a heated oven.
